(19) United States
(12) Patent Application Publication
(10) Pub. No.: US 2026/0131428 A1
(43) Pub. Date: May 14, 2026

(54) APPARATUS AND METHOD FOR A RELEASABLE MODULAR CLAMPING SYSTEM

(71) Applicant: Scott Luggery, Callahan, FL (US)

(72) Inventor: Scott Luggery, Callahan, FL (US)

(21) Appl. No.: 19/384,078

(22) Filed: Nov. 10, 2025

Related U.S. Application Data
(60) Provisional application No. 63/720,707, filed on Nov. 14, 2024.

(51) Int. Cl. B25B 5/08; B25B 5/14

(52) U.S. Cl. CPC B25B 5/08; B25B 5/14

(57) ABSTRACT

An apparatus for a releasable modular clamping system includes a pillar mounted to a fixture, a rotatable camlock housed within the pillar, and an insert that mates with a workpiece. The camlock features a hollow body with a unique full-rail structure comprising an access bore, a narrower, circumferential slot, a wall thickness that increases from an unlocked to locked position, and an edge (contoured inner surface) machined to mate with the underside of a head of an insert. To secure the workpiece, an insert's head is passed through the access bore into the camlock's interior. The camlock is then rotated, trapping the head within the camlock as the narrower slot aligns with the insert's neck. The contoured inner surface provides maximum surface contact with the insert's head, ensuring a rigid, high-strength connection. The system allows for rapid and precise clamping and is adaptable to various workpieces via interchangeable inserts.

This application is a nonprovisional and claims the benefit of priority of U.S. Provisional Application 63/720,707 filed Nov. 14, 2024.

### FIELD OF THE INVENTION

The present invention relates generally to fastening systems for releasably joining one object to another, and more particularly, to a modular work-holding system for use with computer numerical control (CNC) machining operations.

### BACKGROUND OF THE INVENTION

In the field of CNC machining, work-holding systems are critical for securing a workpiece to a fixture or machine table during operation. The precision and quality of the final machined part are directly dependent on the rigidity and accuracy of the clamping mechanism. Conventional modular work-holding systems often present significant challenges. Many existing designs are mechanically complex, comprising numerous components that lead to high manufacturing costs. This expense can be a substantial barrier to adoption, especially for smaller manufacturing operations or those specializing in high-mix, low-volume production runs where frequent setup changes are required.

Furthermore, the setup and reconfiguration of these conventional systems can be time-consuming and cumbersome, reducing machine uptime and overall productivity. Some systems also require invasive preparation of the workpiece material, which adds to the operational time and material cost for each part. With the increasing prevalence of 5-axis milling machines, which offer enhanced flexibility and the ability to machine complex geometries, the limitations of traditional work-holding systems have become more pronounced. Many existing systems fail to provide adequate clearance and access for the cutting tool, thereby failing to optimize the full capabilities of these advanced machines. Consequently, there remains a persistent need for a work-holding solution that is cost-effective, precise, and robust, while also facilitating rapid and repeatable setup and reconfiguration to maximize manufacturing efficiency. There is also a need for a such a holding system that can be used one object to another, even outside the field of a manufacturing.

The invention is directed to overcoming one or more of the problems and solving one or more of the needs as set forth above.

### SUMMARY OF THE INVENTION

The present invention provides a modular clamping apparatus and method for releasably securing a workpiece to a fixture. An object of the invention is to provide a cost-effective work-holding solution that does not sacrifice precision or holding strength. Another object is to provide a system that enables rapid setup and reconfiguration, increasing machine uptime. A further object is to provide a clamping system optimized for use with multi-axis machining centers by providing superior clearance and access to the workpiece.

To achieve these and other objects, an exemplary embodiment of the invention provides a modular clamping apparatus comprising a pillar, a camlock, and an insert. The pillar is configured to be mounted to a fixture and includes a body defining a first counterbore and a central bore. The camlock is a generally cylindrical component rotatably disposed within the pillar's first counterbore. The camlock has a sidewall that defines an interior space, an access bore extending through the sidewall dimensioned to receive the head of an insert, and a slot extending circumferentially from the access bore. The slot is dimensioned to receive the neck of the insert but is narrower than the head, thereby preventing its passage. The insert includes a workpiece-engaging end and a locking end, the locking end comprising the head and the neck.

In operation, the workpiece-engaging end of the insert is mated to a prepared cavity in a workpiece. The locking end of the insert is then presented to the camlock. The camlock is rotated to an unlocked position where the access bore is aligned to receive the head of the insert into the interior space. Once the head is inside, the camlock is rotated to a locked position. This rotation moves the narrower slot into alignment with the neck, trapping the head within the interior space of the camlock and rigidly securing the insert, and thus the workpiece, to the pillar. The camlock features a unique full-rail design with a contoured inner surface that provides maximum surface contact with the underside of the insert's head, enhancing holding strength and distributing stress evenly.

The method of use includes the steps of preparing a cavity in a workpiece, mating an insert to the cavity, inserting a head of the insert through an access bore of a camlock disposed within a pillar, and rotating the camlock to capture the head within the camlock, thereby securing the workpiece to the pillar.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides an exploded view of an exemplary modular clamping system a using a dovetail insert according to principles of the invention;

FIG. 2 provides an exploded view of an exemplary modular clamping system using a threaded insert according to principles of the invention;

FIG. 3 provides an assembled view of the exemplary modular clamping system (without the workpiece) using a dovetail insert according to principles of the invention;

FIG. 4 provides an assembled view of the exemplary modular clamping system (without the workpiece) using a threaded insert according to principles of the invention;

FIG. 5 provides a perspective view of an exemplary pillar for the exemplary modular clamping system according to principles of the invention;

FIG. 6 provides a sectioned perspective view of an exemplary pillar for the exemplary modular clamping system according to principles of the invention;

FIG. 7 provides a perspective view of an exemplary camlock for the exemplary modular clamping system according to principles of the invention;

FIG. 8 provides a first sectioned perspective view of an exemplary camlock for the exemplary modular clamping system according to principles of the invention;

FIG. 9 provides a side view of an exemplary camlock for the exemplary modular clamping system according to principles of the invention;

FIG. 10 provides another perspective view of an exemplary camlock for the exemplary modular clamping system according to principles of the invention;

FIG. 11 provides a plan view from the open end of an exemplary camlock for the exemplary modular clamping system according to principles of the invention;

FIG. 12 provides a section view of an exemplary camlock for the exemplary modular clamping system according to principles of the invention, the section being in a plane transverse to the plane of FIG. 8;

FIG. 13 provides a section view of an exemplary camlock for the exemplary modular clamping system according to principles of the invention, the section being opposite to the section of FIG. 12 and in a plane transverse to the plane of FIG. 8;

FIG. 14 provides a second perspective view of an exemplary camlock for the exemplary modular clamping system according to principles of the invention;

FIG. 15 provides a perspective view of an exemplary dovetail insert for the exemplary modular clamping system according to principles of the invention;

FIG. 16 provides a perspective view of an exemplary threaded insert for the exemplary modular clamping system according to principles of the invention;

FIG. 17 provides a perspective view of an exemplary retaining ring for the exemplary modular clamping system according to principles of the invention;

FIG. 18 provides a perspective view of an exemplary socket head cap screw for the exemplary modular clamping system according to principles of the invention;

FIG. 19 provides a perspective view of an exemplary spring ball detent for the exemplary modular clamping system according to principles of the invention;

FIG. 20 provides a section view of an exemplary spring ball detent for the exemplary modular clamping system according to principles of the invention;

FIG. 21 provides a perspective view of an exemplary fixture for the exemplary modular clamping system according to principles of the invention;

FIG. 22 provides a sectioned perspective view of an exemplary fixture for the exemplary modular clamping system according to principles of the invention;

FIG. 23 provides a perspective view of a workpiece with a dovetail preparation for the exemplary modular clamping system according to principles of the invention;

FIG. 24 provides a section view of a workpiece with a dovetail preparation for the exemplary modular clamping system according to principles of the invention;

FIG. 25 provides a plan view of a workpiece with a dovetail preparation for the exemplary modular clamping system according to principles of the invention; and

FIG. 26 provides a section view of a workpiece with a threaded preparation for the exemplary modular clamping system according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION OF THE INVENTION

With reference to the Figures, exemplary modular clamping systems 100 and 101 provide a robust and precise mechanism for securing a workpiece 102, 110 to a fixture 109 during machining operations. The systems are designed for rapid engagement and disengagement while providing exceptional holding force. Although the system is particularly well suited for CNC machining applications, its design allows it to be applied to other releasable holding situations.

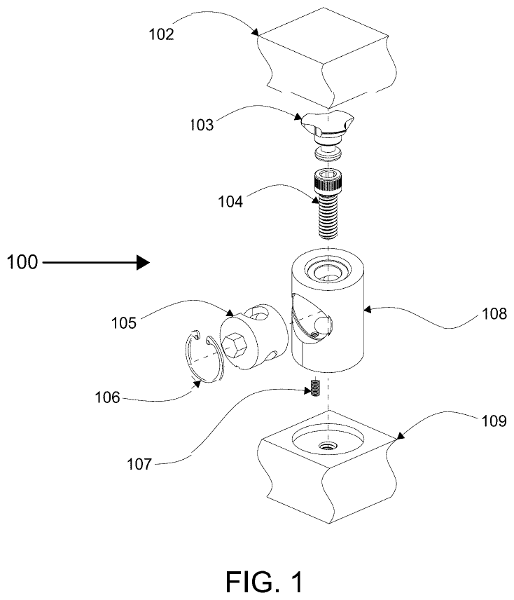

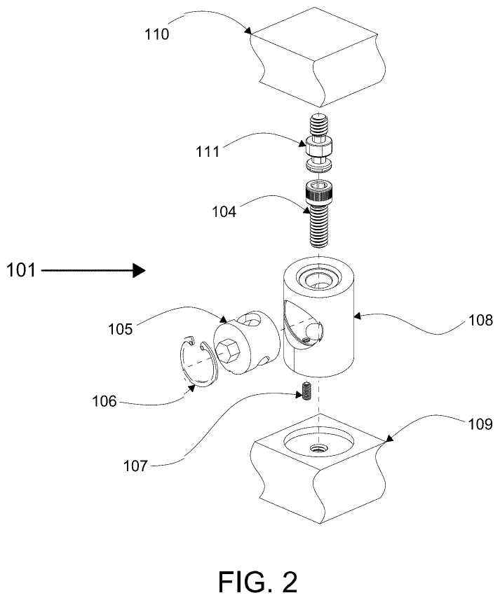

As shown in the exploded views of FIGS. 1 and 2, the core components of the system include a pillar 108, a camlock 105, an insert 103 or 111, and a fastener 104 for mounting the pillar 108 to a fixture 109. The system may further include a retaining ring 106 and a spring-ball detent 107. The primary difference between system 100 (FIG. 1) and system 101 (FIG. 2) is the type of insert and corresponding workpiece preparation. System 100 utilizes a dovetail insert 103 that mates with a workpiece 102 having a dovetail preparation 803, while system 101 utilizes a threaded insert 111 that mates with a workpiece 110 having a threaded preparation.

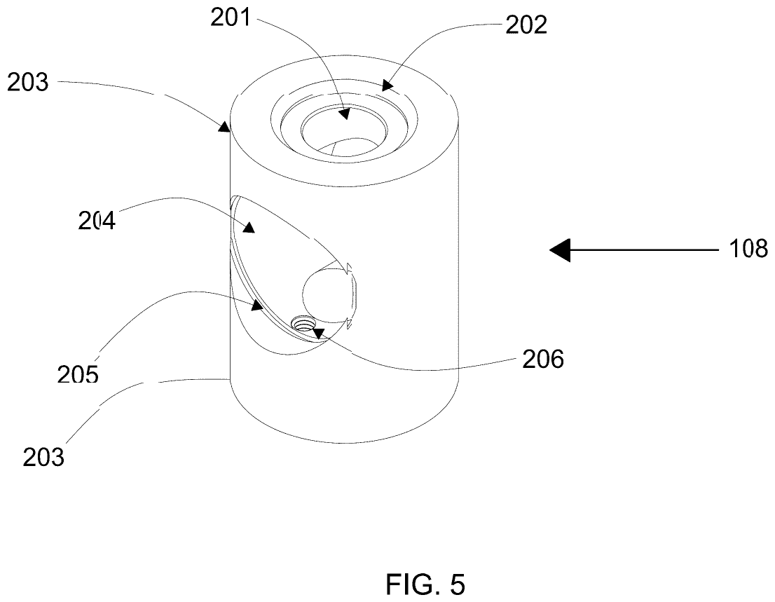

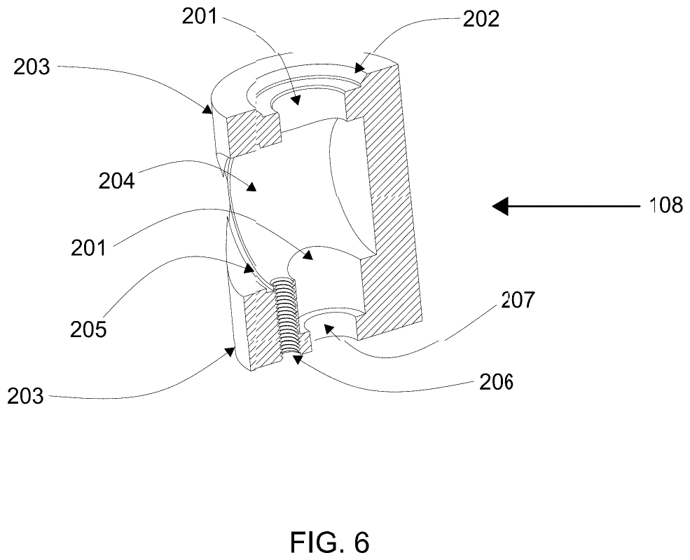

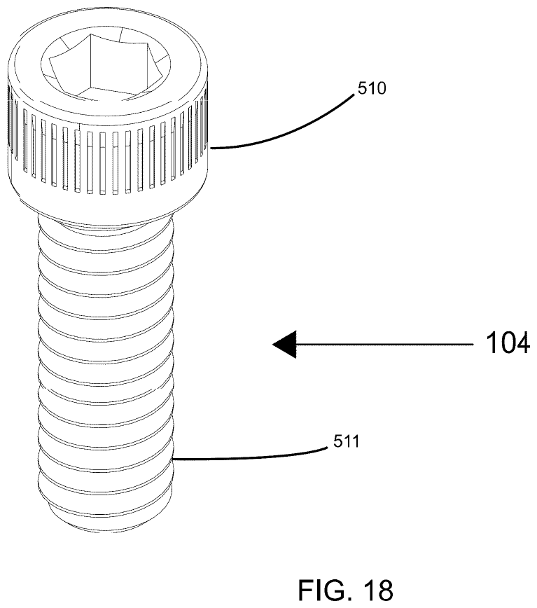

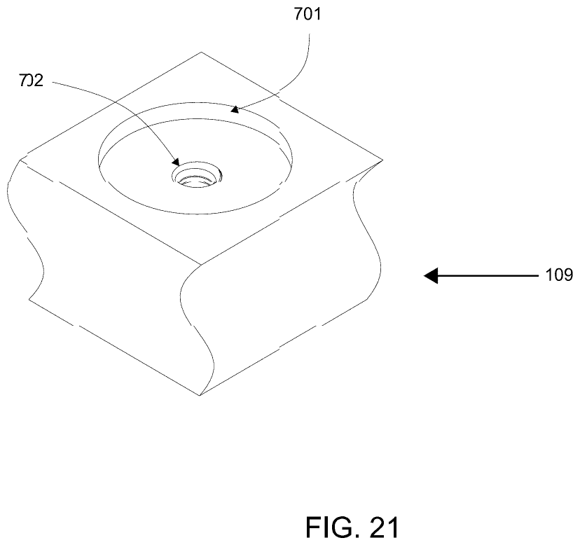

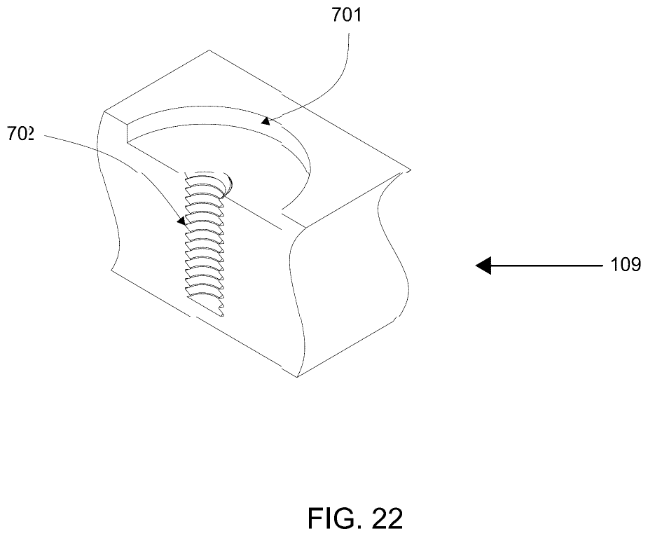

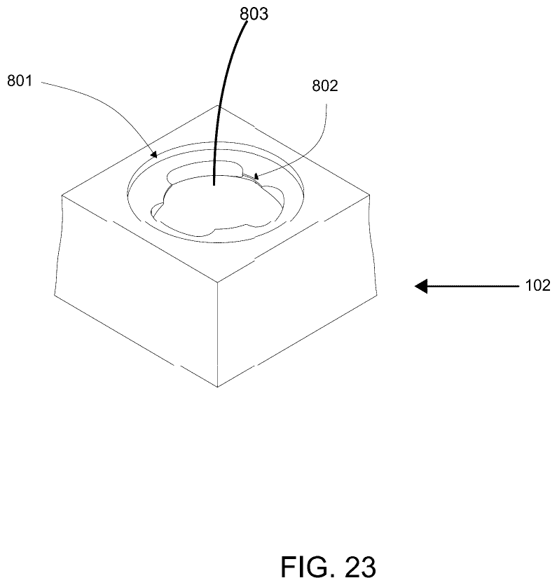

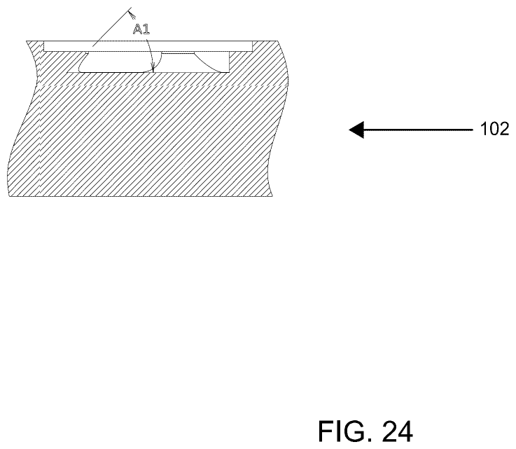

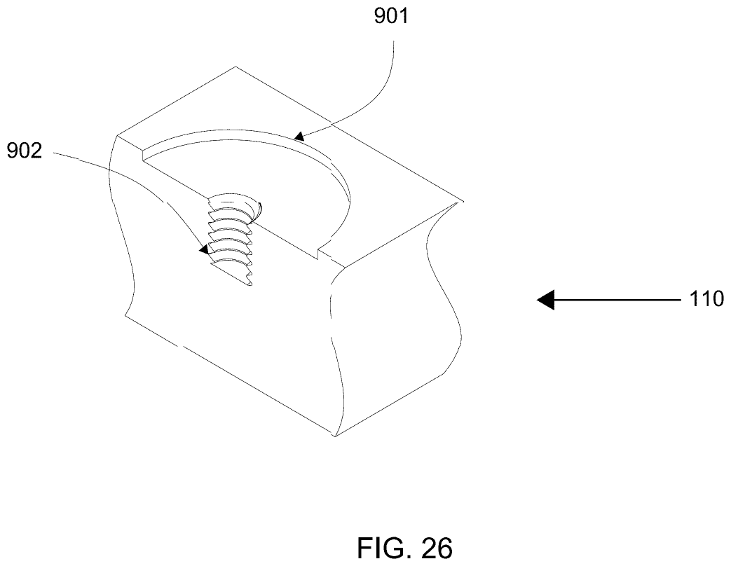

The pillar 108, shown in detail in FIGS. 5 and 6, serves as the foundational mounting element. It is a generally cylindrical body having a precision outer diameter 203 that may interface with a corresponding precision counterbore 701 in the fixture 109 (FIGS. 21-22) or a precision counterbore 801, 901 in the workpiece 102, 110 (FIGS. 23, 26). The pillar 108 has a central thru-hole 207 that opens into a counterbore 201 at one end. This counterbore 201 is dimensioned to receive the head 510 of a fastener, such as the socket head cap screw 104 (FIG. 18), allowing the shank 511 of the screw 104 to pass through the hole 207 and engage a threaded hole 702 in the fixture 109 to securely mount the pillar 108. The pillar 108 also features a transverse counterbore 204 in its sidewall, which is precisely machined to rotatably receive the camlock 105. An annular retaining ring groove 205 is machined into the opening of the counterbore 204 to seat the retaining ring 106. A threaded hole 206 is provided to accept the threaded body 602 of the spring-ball detent 107. A clearance pocket 202 may be provided at the opening of the central counterbore 201 to provide nesting engagement for the insert.

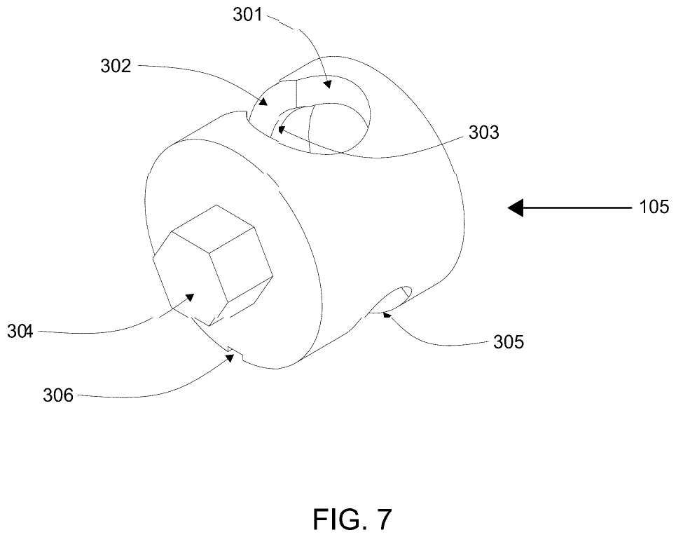

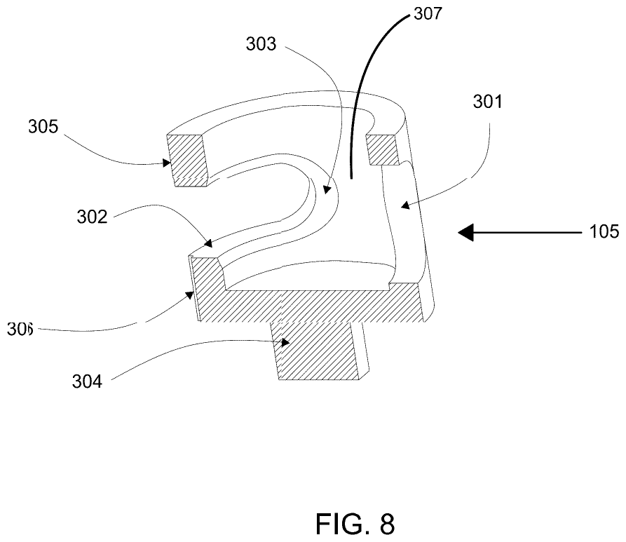

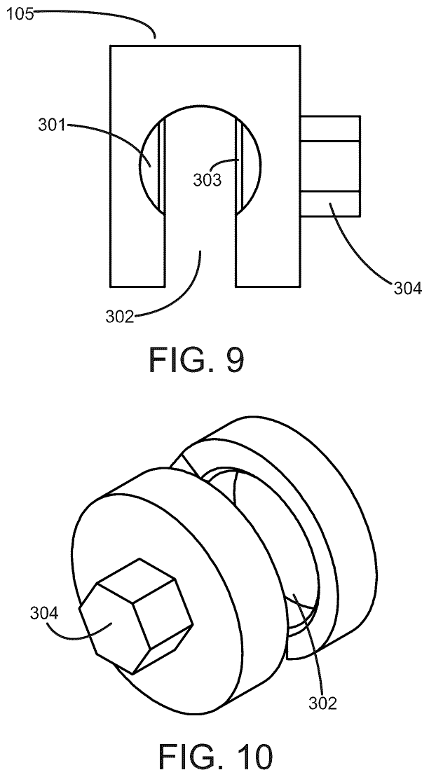

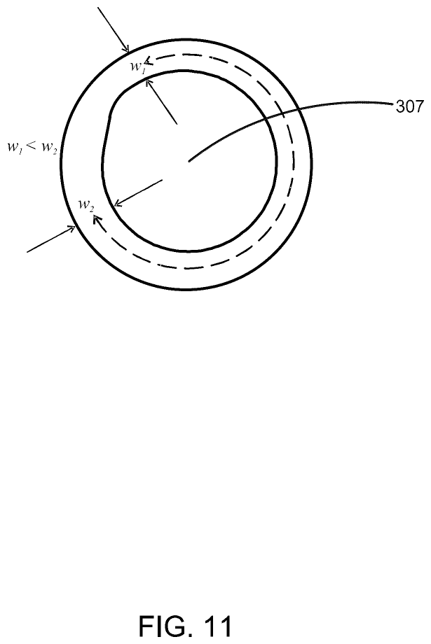

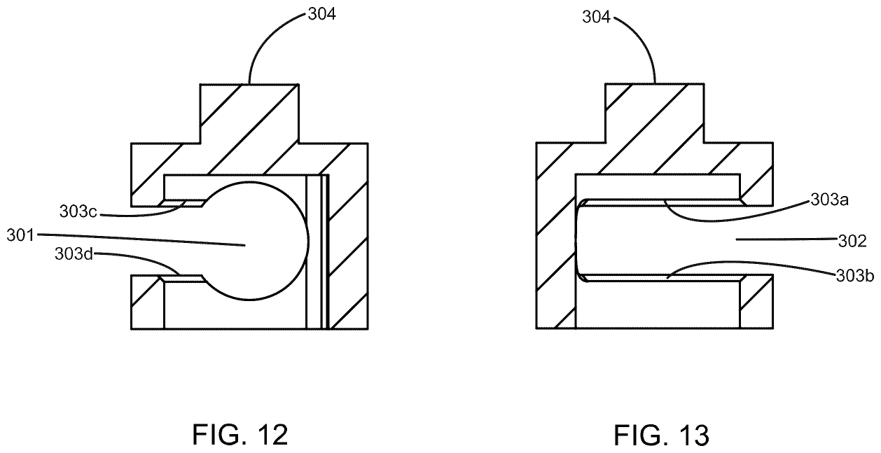

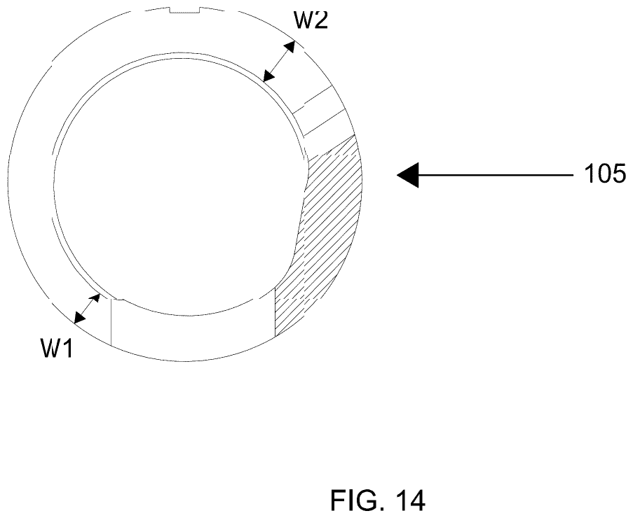

The camlock 105, detailed in FIGS. 7-14, is the primary locking component. It is a hollow cylindrical structure with a closed end and an opposite open end defining an interior space 307. The interior space 307 is noncircular in cross-section shape, as shown in FIG. 11. An external drive feature 304, such as a hexagonal boss, is provided on the closed end to allow a user to apply torque with a wrench for rotation. The sidewall of the camlock 105 features a unique full rail 305 structure for engaging the insert. This full rail 305 is comprised of an access bore 301 and a slot 302. The access bore 301 is dimensioned to allow passage of the head 404, 501 of an insert. The slot 302, which extends circumferentially from the access bore 301 for at least 180 degrees, is narrower than the access bore 301. It is dimensioned to accommodate the neck 403, 502 of the insert but is too narrow for the head 404, 501 to pass through. A critical feature is the contoured surface 303 along the inner edge of the slot 302. This surface, shown in segments 303a, 303b, 303c, 303d in FIGS. 12-13, is precisely machined to match the geometry of the underside of the insert's head, ensuring maximum surface contact. This feature distributes clamping forces over a broader area, increasing holding strength and preventing damage. As shown in FIGS. 11 and 14, the wall thickness of the camlock 105 may vary, increasing from a first thickness w₁ near the access bore 301 to a second, greater thickness w₂ at the distal end of the slot 302. This progressively increasing thickness acts as a wedge, tightening the engagement and eliminating play as the camlock 105 is rotated to the locked position. An external detent groove 306 may be provided to interact with the ball detent 107.

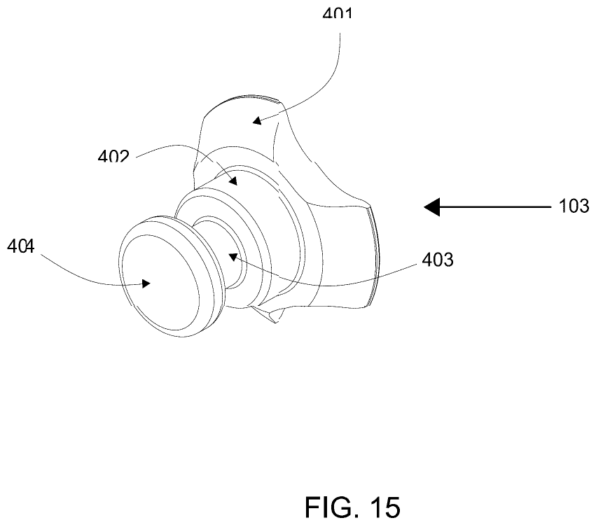

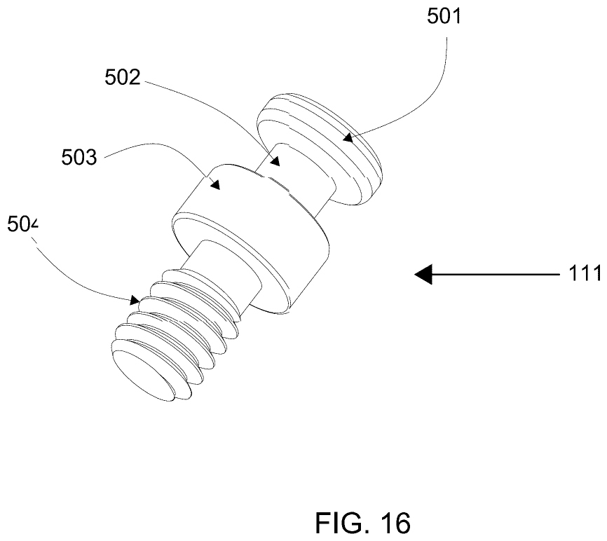

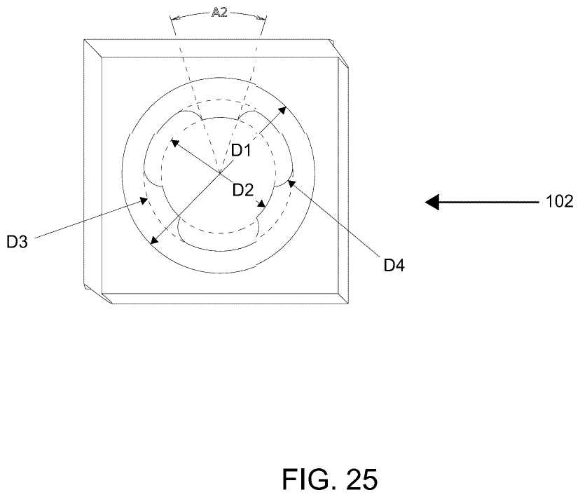

The system utilizes interchangeable inserts to accommodate different workpieces. Each insert includes a mating end and a locking end. The dovetail insert 103 (FIG. 15) includes one or more feet 401 configured to mate with a dovetail preparation 803 (FIGS. 23-25) in a workpiece 102. The locking end of the insert 103 comprises a head 404, a neck 403, and a shoulder 402. The threaded insert 111 (FIG. 16) includes a threaded end 504 configured to engage a threaded hole 902 in a workpiece 110 (FIG. 26). Its locking end similarly comprises a head 501, a neck 502, and a shoulder 503. In both cases, the head 404, 501 has a larger diameter than the neck 403, 502, enabling the head 404, 501 to be trapped within the cam lock 105 while the neck extends through the cam lock slot 302.

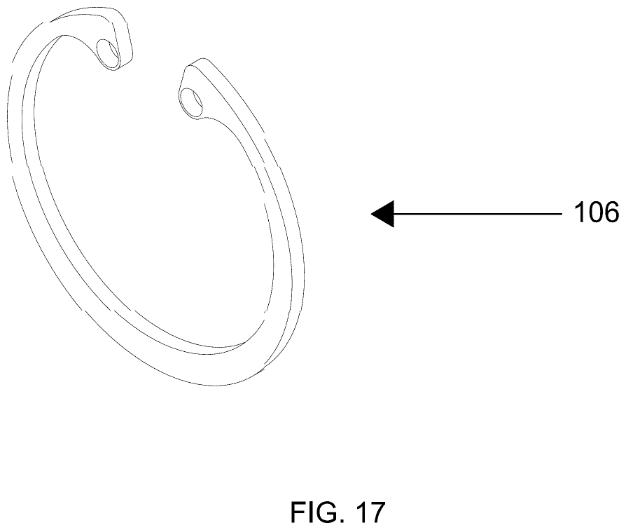

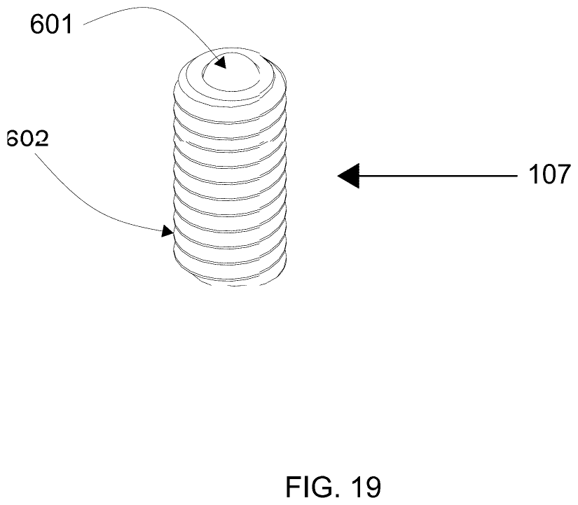

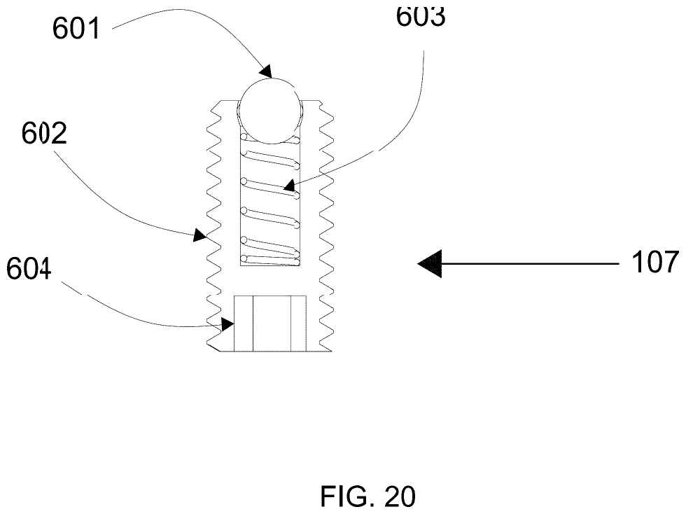

Accessory components complete the assembly. The retaining ring 106 (FIG. 17) is an internal retaining ring that is compressed and seated in the groove 205 of the pillar 108 after the camlock 105 is inserted into the counterbore 204. This ring 106 prevents the camlock 105 from being unintentionally withdrawn from the pillar 108. The spring-ball detent 107 (FIGS. 19-20) includes a threaded body 602, a ball 601, and an internal spring 603. It is threaded into the hole 206 in the pillar 108 so that the spring-loaded ball 601 engages the outer surface of the camlock 105, clicking into the detent groove 306. The ball detent interfaces with the detent groove 306 on the cam lock to provide tactile feedback and indexing between locked and unlocked positions. A drive feature 604 (e.g., a socket for an Allen wrench to facilitate threading the threaded body 602 into a threaded hole 206) facilitates installation.

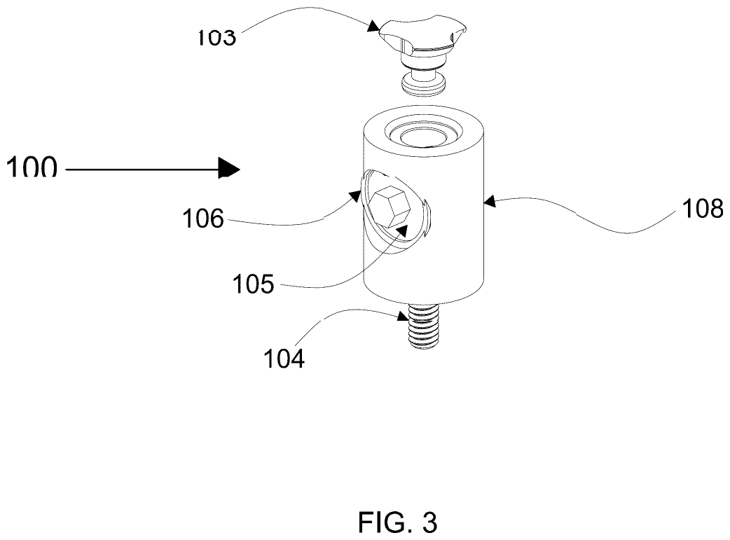

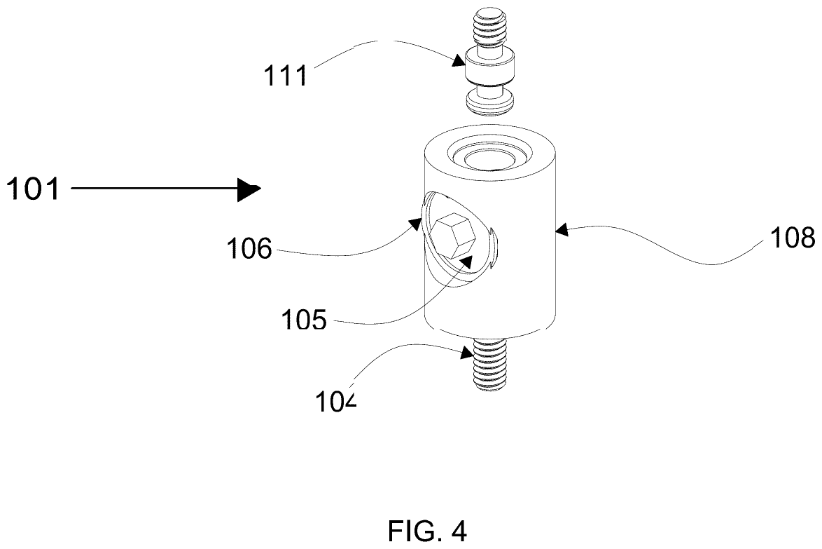

The method of use begins with preparing the workpiece 102, 110. The workpiece 102 is machined with a preparation cavity—either a dovetail preparation 803 or a threaded preparation 902—to accept a corresponding insert 103 or 111. As shown in FIGS. 23-26, a preparation is machined into the stock material. The preparation may be performed using standard machining processes, including milling, boring, and threading. For a dovetail connection, a dovetail preparation 803 is created, comprising a precision counterbore 801 and undercut dovetail teeth 802 at a specific angle A1, A2 and diameters d1, d2, d3, d4. These angles and diameters are selected to accommodate the dovetail without appreciable play. For a threaded connection, a threaded preparation is created, comprising a precision counterbore 901 and a threaded hole 902. Next, the appropriate insert 103, 111 is mated to the workpiece preparation. The pillar 108 is then securely mounted to an object such as a fixture 109 using the fastener 104. With the camlock 105 rotated to the unlocked position (aligning access bore 301 with the central bore of the pillar), the insert/workpiece assembly is presented to the pillar 108. The head 404, 501 of the insert passes through the access bore 301 into the interior space 307 of the camlock. An operator then uses a tool to engage the drive feature 304 and rotate the camlock 105. This rotation misaligns the head 404, 501 with the access bore 301 and brings the narrower slot 302 into alignment with the neck 403, 502, while the wedge-action of the increasing wall thickness eliminates any play and achieves a tight secure capture of the head 404, 501. The contoured surface 303 engages the underside of the head 404, 501, pulling the workpiece firmly against the pillar and locking it rigidly in place, as shown in the assembled views of FIGS. 3 and 4. To release the workpiece, the process is reversed.

Assembly proceeds by mounting the pillar 108 to the fixture 109 with the socket head cap screw 104. The insert is installed into the workpiece preparation, such that the neck and head extend outward from the workpiece. The cam lock 105 is rotated so that the bore 301 is aligned to receive the insert head. The head passes into the cam lock interior, and the neck extends through the slot. The cam lock is then rotated to bring the narrower slot section under the head, thereby trapping it. The ball detent 107 indexes into the detent groove 306, providing a click indicating the locked position. The retaining ring 106 ensures the cam lock remains in place during use. To release, the cam lock is rotated in the opposite direction to realign the bore with the head, allowing the insert to be removed.

The components may be manufactured from high-strength, corrosion-resistant materials such as stainless steel or tool steel. Surfaces may be precision ground or machined to ensure repeatability and minimize deflection. The cam lock geometry enables rapid tool-less or single-tool actuation with minimal rotation, while maintaining exceptional holding force and alignment.

Although the system is shown in a machining context, it may also be adapted to other applications requiring releasable joining, including modular fixturing, tooling plates, structural frameworks, or transport assemblies. Variations may include inserts of alternative geometry, cam locks with different drive features, detent mechanisms of different form, and materials selected for specific use environments.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A modular clamping apparatus for releasably securing a workpiece, the apparatus comprising:
a pillar configured to be mounted to a fixture, said pillar having a body defining a first counterbore;
a camlock rotatably disposed within said first counterbore of said pillar, said camlock having a sidewall defining an interior space, an access bore extending through said sidewall, and a slot extending circumferentially from said access bore, wherein said sidewall has a wall thickness that progressively increases from a first thickness adjacent said access bore to a second, greater thickness at a distal end of said slot; and
an insert having a workpiece-engaging end and a locking end, said locking end comprising a head and a neck, said head having a first diameter and said neck having a second diameter smaller than said first diameter;
wherein said access bore is dimensioned to permit passage of said head into said interior space when said camlock is in an unlocked position, and wherein said slot is dimensioned to permit passage of said neck but prevent passage of said head, thereby capturing said head within said interior space when said camlock is rotated to a locked position.

2. The apparatus of claim 1, wherein said workpiece-engaging end of said insert comprises at least one dovetail foot configured to mate with a corresponding dovetail preparation in the workpiece.

3. The apparatus of claim 1, wherein said workpiece-engaging end of said insert comprises a threaded shank configured to mate with a corresponding threaded hole in the workpiece.

4. The apparatus of claim 1, further comprising a retaining ring, wherein said pillar defines an annular groove in said first counterbore, and wherein said retaining ring is seated in said annular groove to prevent withdrawal of said camlock from said first counterbore.

5. The apparatus of claim 1, further comprising a spring-ball detent mounted to said pillar and engaging an outer surface of said camlock to provide tactile feedback corresponding to said locked and unlocked positions.

6. The apparatus of claim 1, wherein said camlock further comprises a contoured inner surface adjacent to said slot, said contoured inner surface being shaped to mate with an underside of said head to provide maximum surface contact upon engagement.

7. The apparatus of claim 1, wherein said sidewall of said camlock has a wall thickness that increases circumferentially from a first thickness adjacent said access bore to a second, greater thickness at a distal end of said slot.

8. A camlock for a modular clamping apparatus, the camlock comprising:
a generally hollow cylindrical body having a sidewall, a closed end, and an open end defining an interior space;
an access bore extending through said sidewall, said access bore being dimensioned to receive a head of an insert therethrough;
a slot extending circumferentially from said access bore along said sidewall, said slot being narrower than said access bore and being dimensioned to receive a neck of the insert; and
a contoured inner surface formed on an interior of said sidewall adjacent to said slot, said contoured inner surface configured to mate with an underside of the head of the insert when the neck is positioned in said slot.

9. The camlock of claim 8, wherein said slot extends at least 180 degrees around said sidewall.

10. The camlock of claim 8, further comprising a drive feature formed on said closed end, said drive feature being configured for engagement by a tool to rotate said camlock.

11. The camlock of claim 10, wherein said drive feature is a hexagonal boss.

12. The camlock of claim 8, further comprising at least one detent groove formed on an outer surface of said cylindrical body.

13. The camlock of claim 8, wherein said sidewall has a wall thickness that progressively increases from a first thickness adjacent said access bore to a second, greater thickness at a distal end of said slot.

14. The camlock of claim 8, wherein said contoured inner surface, said access bore, and said slot together form a full-rail structure for capturing the head of the insert.

15. A method of releasably clamping a workpiece, the method comprising the steps of:
providing a pillar having a first counterbore;
providing a camlock rotatably disposed within the first counterbore, the camlock having a sidewall progressively increasing thickness and a contoured inner surface shaped to match an underside of a head of an insert, the sidewall further defining an interior space, an access bore, and a slot extending from the access bore;
providing an insert having a workpiece-engaging end and a locking end, the locking end comprising a head and a neck;
preparing a cavity in a workpiece;
mating the workpiece-engaging end of the insert to the cavity in the workpiece;
aligning the access bore of the camlock to an unlocked position and inserting the head of the insert through the access bore into the interior space of the camlock; and
rotating the camlock to a locked position, thereby moving the slot into alignment with the neck and causing the contoured inner surface to engage the underside of the head while the progressively increasing thickness of the sidewall creates a wedging force against the head that tightens the engagement, and capturing the head within the interior space to secure the workpiece to the pillar.

16. The method of claim 15, wherein the step of preparing a cavity in the workpiece comprises machining a dovetail preparation.

17. The method of claim 15, wherein the step of preparing a cavity in the workpiece comprises machining a threaded hole.

18. The method of claim 15, further comprising the step of securing the pillar to a fixture with a fastener prior to inserting the head of the insert.

19. The method of claim 15, wherein the step of rotating the camlock to a locked position causes a contoured inner surface of the camlock to engage an underside of the head.

20. The method of claim 15, wherein the step of rotating the camlock engages a detent mechanism coupled to the pillar, thereby providing tactile feedback that the locked position has been reached.
